(19) United States
(12) Patent Application Publication
(10) Pub. No.: US 2026/0004522 A1
(43) Pub. Date: Jan. 1, 2026

(54) CREATING VIRTUAL THREE-DIMENSIONAL SPACES USING GENERATIVE MODELS

(71) Applicant: Microsoft Technology Licensing, LLC, Redmond, WA (US)

(72) Inventors: Andrew D. WILSON, Seattle, WA (US); Nicolai MARQUARDT, Sammamish, WA (US); Balasaravanan Thoravi KUMARAVEL, Bellevue, WA (US); Nels NUMAN, Redmond, WA (US); Swetha RAJARAM, Ann Arbor, MI (US)

(73) Assignee: Microsoft Technology Licensing, LLC, Redmond, WA (US)

(21) Appl. No.: 18/756,717

(22) Filed: Jun. 27, 2024

(51) Int. Cl. G06T 17/20; G06T 5/77; G06T 7/55; G06T 19/20

(52) U.S. Cl. CPC G06T 17/20; G06T 5/77; G06T 7/55; G06T 19/20; G06T 2207/10024; G06T 2207/10028; G06T 2207/30196; G06T 2219/2004

(57) ABSTRACT

This document relates to generation of three-dimensional virtual spaces from user-provided two-dimensional input images. For instance, three-dimensional submeshes can be derived from the user-provided two-dimensional input images. Then, the submeshes can be arranged in a submesh layout, with spaces between the submeshes. The spaces can be populated with image content generated by a generative image model, which is then blended with the submeshes, resulting in a final three-dimensional virtual space.

### BACKGROUND

One use case for computing devices involves generation of three-dimensional virtual spaces. In some cases, virtual spaces are entirely synthetic, e.g., they are generated without reference to any real-world environment. However, these approaches can place users in generic, unfamiliar three-dimensional environments.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for image generation. One example includes a computer-implemented method that can include receiving input images. The method can also include generating three-dimensional submeshes from the input images. The method can also include generating a submesh layout from the three-dimensional submeshes, the submesh layout having spaces between the three-dimensional submeshes. The method can also include using a generative image model, generating image content for the spaces in the submesh layout. The method can also include combining the generated image content with the three-dimensional submeshes into a three-dimensional virtual space. The method can also include outputting the three-dimensional virtual space.

Another example entails a system that includes a processor and a storage medium storing instructions. When executed by the processor, the storage medium storing instructions can cause the system to receive a three-dimensional virtual space, the three-dimensional virtual space having been generated from multiple input images according to a submesh layout and having image content generated by a generative image model for spaces in the submesh layout. The instructions can also cause the system to render portions of the three-dimensional virtual space in response to received user input.

Another example includes a computer-readable storage medium storing executable instructions which, when executed by a processor, cause the processor to perform acts. The acts can include receiving input images. The acts can also include generating three-dimensional submeshes from the input images. The acts can also include generating a submesh layout from the three-dimensional submeshes, the submesh layout having spaces between the three-dimensional submeshes. The acts can also include using a generative image model, generating image content for the spaces in the submesh layout. The acts can also include combining the generated image content with the three-dimensional submeshes into a three-dimensional virtual space.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example generative language model, consistent with some implementations of the present concepts.

FIG. 2 illustrates an example generative image model, consistent with some implementations of the present concepts.

FIGS. 3A, 3B, 3C, and 3D illustrate example input images, consistent with some implementations of the present concepts.

FIGS. 4A, 4B, and 4C illustrate example views of a three-dimensional virtual space, consistent with some implementations of the present concepts.

FIG. 5A illustrates an example pipeline for generating a three-dimensional virtual space from input images, consistent with some implementations of the present concepts.

FIG. 5B illustrates an example of removing a person from an input image and filling in a background, consistent with some implementations of the present concepts.

FIG. 5C illustrates an example of adding a floor to an input image, consistent with some implementations of the present concepts.

FIG. 5D illustrates an example of a submesh layout, consistent with some implementations of the present concepts.

FIG. 6 illustrates an example of a system in which the disclosed implementations can be performed, consistent with some implementations of the present concepts.

FIG. 7 illustrates an example method or technique, consistent with some implementations of the disclosed techniques.

### DETAILED DESCRIPTION

### Overview

As noted above, one way to generate a three-dimensional virtual space is to synthesize the entire three-dimensional virtual space from scratch. In other words, the three-dimensional virtual space lacks any connection to a particular real-world environment. In other cases, a three-dimensional virtual space can incorporate content from a single image or text example, but this approach is also quite limiting.

The disclosed implementations can employ generative models to create blended three-dimensional virtual spaces from multiple image sources. For instance, the disclosed techniques can obtain two-dimensional images of different environments and transform the two-dimensional images into a three-dimensional virtual space. The transformation can involve estimating depth from the two-dimensional images, spatial alignment of the two-dimensional images, and completing the three-dimensional virtual space using a generative image model. The process can be guided using geometric priors and adaptive image generation prompts that can be obtained from a generative language model.

### Machine Learning Overview

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLAMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models certain GPT variants such as GPT-40, variants of Gemini, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Decoder-Based Generative Language Model

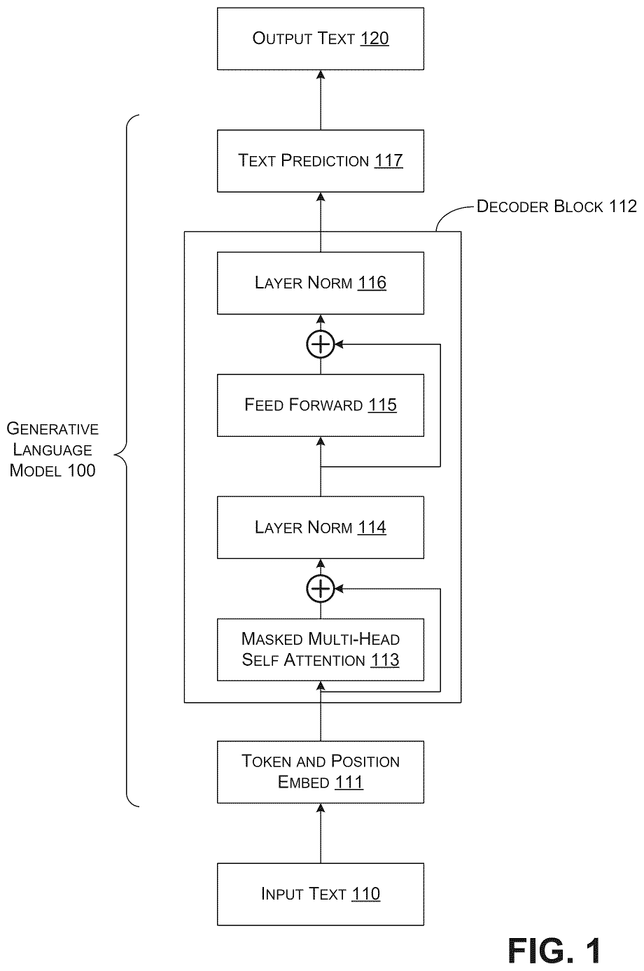

FIG. 1 illustrates an exemplary generative language model 100 (e.g., a transformer-based decoder) that can be employed using the disclosed implementations. Generative language model 100 is an example of a machine learning model that can be used to perform one or more natural language processing tasks that involve generating text, as discussed more below. For the purposes of this document, the term “natural language” means language that is normally used by human beings for writing or conversation.

Generative language model 100 can receive input text 110, e.g., a prompt from a user or a prompt generated automatically by machine learning using the disclosed techniques. For instance, the input text can include words, sentences, phrases, or other representations of language. As discussed more below, in some implementations, the input text can characterize input images. The input text can be broken into tokens and mapped to token and position embeddings 111 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 111 are processed in one or more decoder blocks 112. Each decoder block implements masked multi-head self-attention 113, which is a mechanism relating different positions of tokens within the input text to compute the similarities between those tokens. Each token embedding is represented as a weighted sum of other tokens in the input text. Attention is only applied for already-decoded values, and future values are masked. Layer normalization 114 normalizes features to mean values of 0 and variance to 1, resulting in smooth gradients. Feed forward layer 115 transforms these features into a representation suitable for the next iteration of decoding, after which another layer normalization 116 is applied. Multiple instances of decoder blocks can operate sequentially on input text, with each subsequent decoder block operating on the output of a preceding decoder block. After the final decoding block, text prediction layer 117 can predict the next word in the sequence, which is output as output text 120 in response to the input text 110 and also fed back into the language model. The output text can be a newly-generated response to the prompt provided as input text to the generative language model. As discussed more below, in some implementations, the output text can include image generation prompts for completing a three-dimensional virtual space based on one or more input images.

Generative language model 100 can be trained using techniques such as next-token prediction or masked language modeling on a large, diverse corpus of documents. For instance, the text prediction layer 117 can predict the next token in a given document, and parameters of the decoder block 112 and/or text prediction layer can be adjusted when the predicted token is incorrect. In some cases, a generative language model can be pretrained on a large corpus of documents (Radford, et al., “Improving language understanding by generative pre-training,” 2018). Then, a pretrained generative language model can be tuned using a reinforcement learning technique such as reinforcement learning from human feedback (“RLHF”).

### Example Generative Image Model

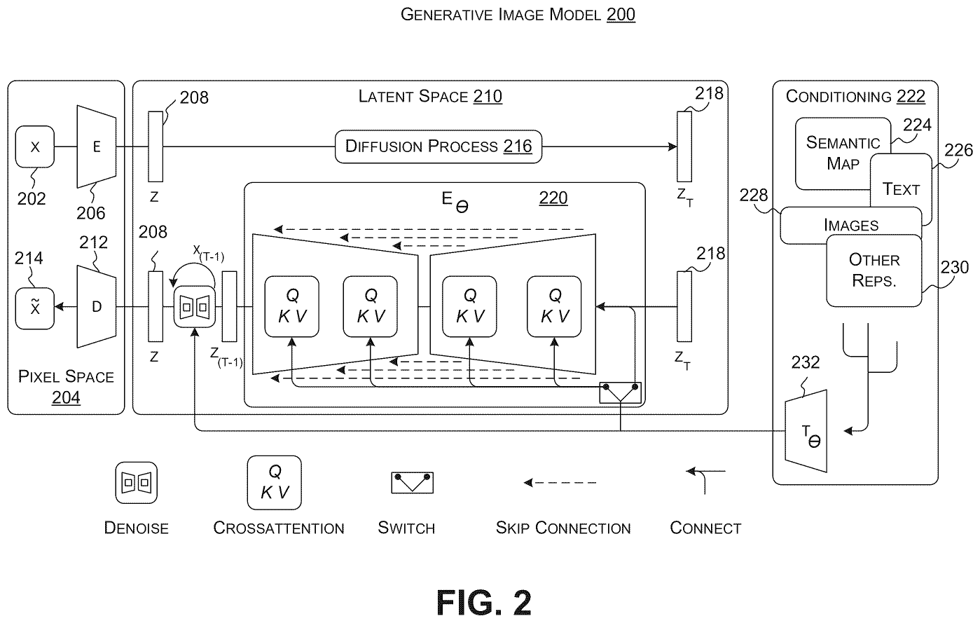

FIG. 2 illustrates an example generative image model 200. An image 202 (X) in pixel space 204 (e.g., red, green, blue) is encoded by an encoder 206 (E) into a representation 208 (Z) in a latent space 210. A decoder 212 (D) is trained to decode the latent representation Z to produce a reconstructed image 214 (X˜) in the pixel space. For instance, the encoder can be trained (with the decoder) as a variational autoencoder using a reconstruction loss term with a regularization term.

In the latent space 210, a diffusion process 216 adds noise to obtain a noisy representation 218 (Z_{T}). A denoising component 220 (Eₑ) is trained to predict the noise in the compressed latent image Z_{T}. The denoising component can include a series of denoising autoencoders implemented using UNet 2D convolutional layers.

The denoising can involve conditioning 222 on other modalities, such as a semantic map 224, text 226, images 228, or other representations 230 which can be processed to obtain an encoded representation 232 (Tₑ). For instance, text (e.g., an image generation prompt) can be encoded using a text encoder (e.g., BERT, CLIP, etc.) to obtain the encoded representation. This encoded representation can be mapped to layers of the denoising component using cross-attention. The result is a text-conditioned latent diffusion model that can be employed to generate images conditioned on text inputs. To train a model such as CLIP, pairs of images and captions can be obtained from a dataset to encode both the images and captions, and the encoder can be trained to represent pairs of images and captions with similar embeddings.

Generative image model 200 can be employed for text to image generation, where an image is generated from a text prompt. Text prompts can be provided by users or generated automatically by machine learning using the disclosed techniques. In other cases, generative image model 200 can be employed for image-to-image mode, where an image is generated using an input image as well as a user or machine-generated text prompt. Generative image model 200 can also be employed for inpainting, where parts of an image are masked and remain fixed while the rest of the image is generated by the model, in some cases conditioned on a user or machine-generated text prompt.

In some cases, generative image model 200 can be implemented as a Stable Diffusion model (Rombach, et al., “High-Resolution Image Synthesis with Latent Diffusion Models,” Proceedings of the IEEE/CVF Conference on Computer Vision and Pattern Recognition, 2022), which can be guided by a separate network, such as a ControlNet (Zhang, et al., “Adding Conditional Control to Text-to-Image Diffusion Models,” Proceedings of the IEEE/CVF International Conference on Computer Vision, 2023). For instance, a ControlNet can guide the generative model to produce an image that preserves certain aspects of another image, e.g., the spatial layout and salient features of an image prior. A ControlNet can be implemented by locking the parameters of generative image model 200, cloning the model into another copy. The copy is connected to the original model with one or more zero convolutional layers which are then optimized with the parameters of the copy. For instance, the ControlNet can be trained to preserve edges, lines, boundaries, human poses, semantic segmentations, etc. from an image. A ControlNet can also be trained to preserve depth relationships of a user-identified image using a depth map obtained from the user-identified image, etc. The outputs of a ControlNet can be added to connections within the denoising layer. Thus, the generative image model can produce images that are conditioned not only on text, but also aspects of another image. As described more below, the resulting images can be employed to provide three-dimensional virtual spaces based on input images received from users.

### Generative Modes

Generative image model 200 can implement a number of different modes. In a text-to-image mode, an image is generated from a given text prompt. In an image-to-image mode, an image is generated from a text prompt and an input image, and the generated image retains features of the input image while introducing new elements or styles consistent with the prompt. In inpainting/outpainting mode, the processing is similar to the image-to-image mode, but an image mask is used to determine which parts of the image are fixed to match the input image. The rest of the image is generated in a way that it is consistent with the fixed parts of the image. Note that the term “inpainting,” as used herein, includes filling in parts of a given image whereas “outpainting” refers to extending an image outward.

### Example User Experience

The following describes an example user experience that can be created using four user-provided images to create a blended three-dimensional virtual space. The examples below are intended to provide an overview of how different images can be combined into a single three-dimensional space with additional content added by a generative image model. A specific algorithm for generating such a three-dimensional virtual space is provided after introducing the example user experience.

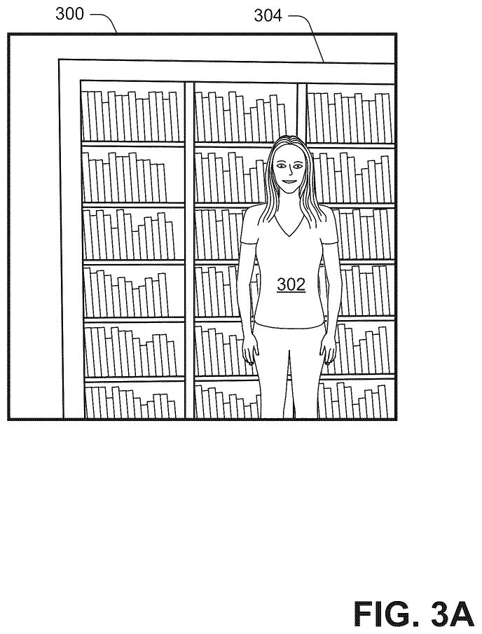

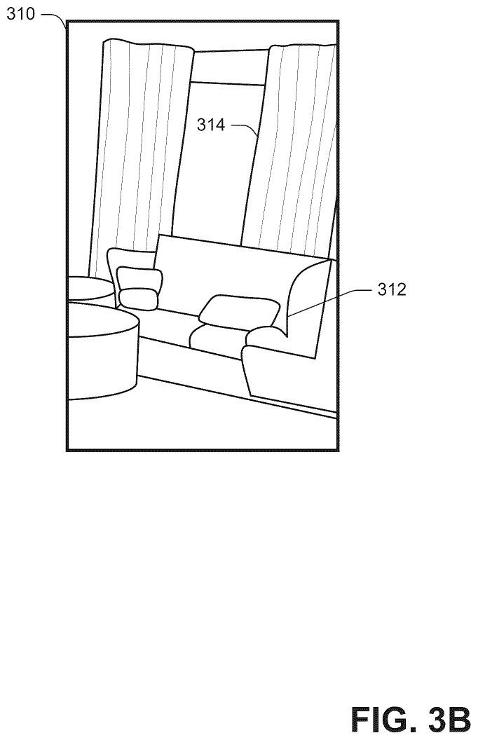

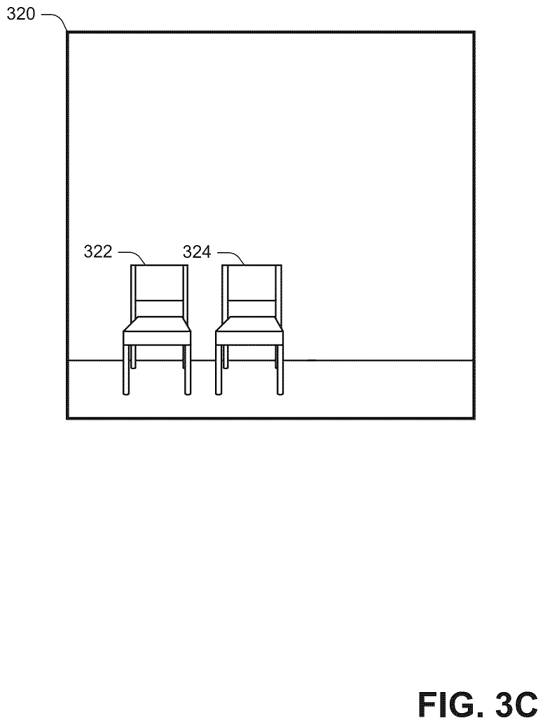

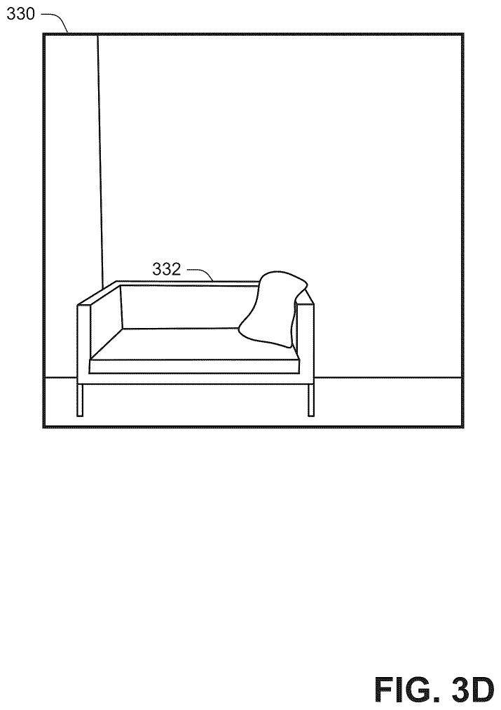

FIG. 3A shows a first user image 300 with a user 302 in front of a bookshelf 304. FIG. 3B shows a second user image 310 with a couch 312 in front of a window with curtains 314. FIG. 3C shows a third user image 320 with a chair 322 and a chair 324. FIG. 3D shows a fourth user image 330 with a sofa 332. Note that not all objects in the images are labeled with reference numbers.

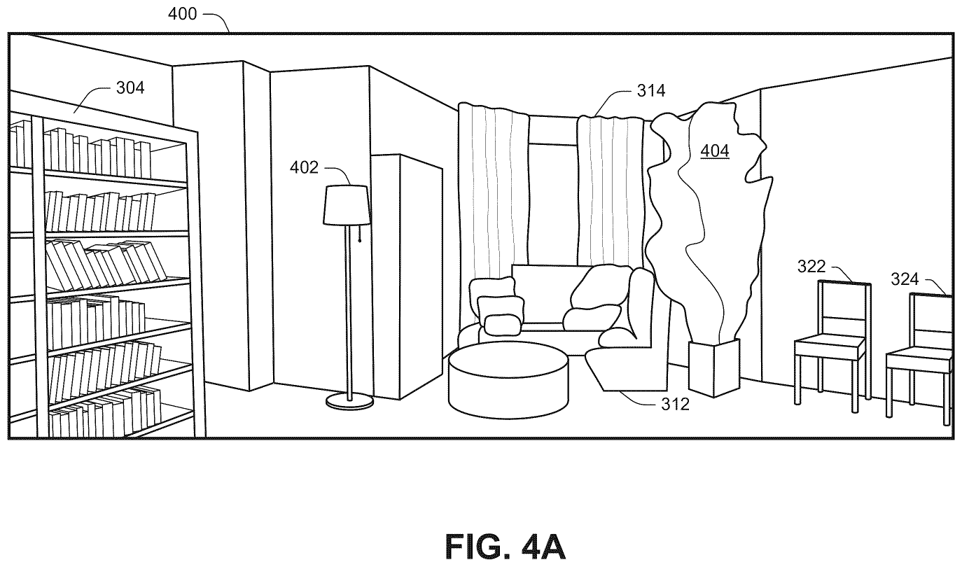

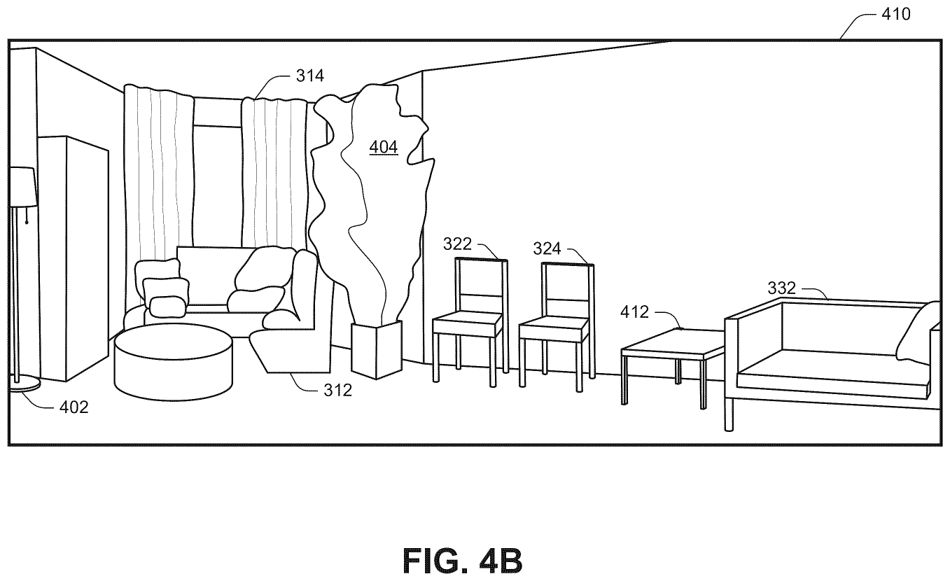

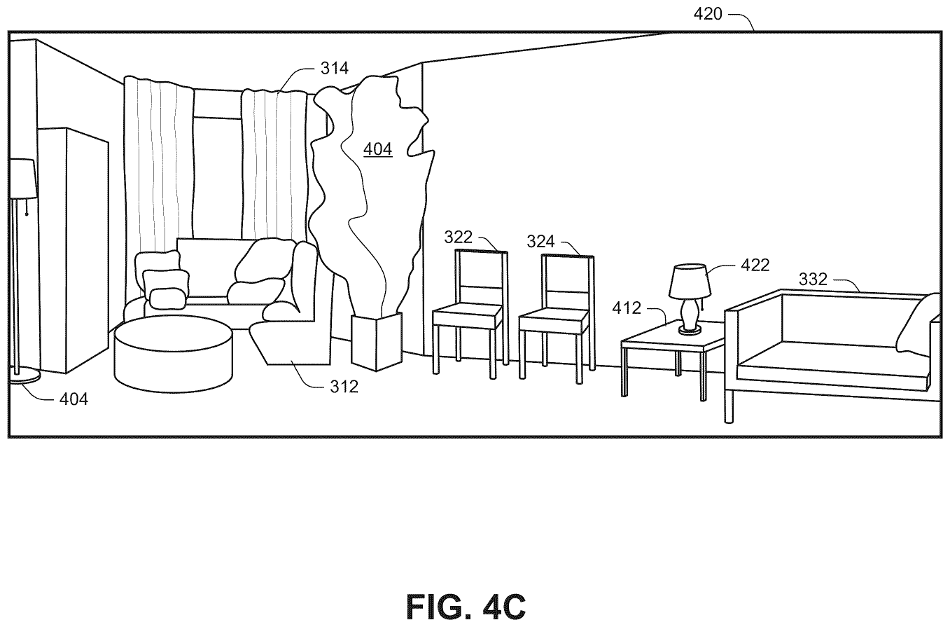

From the four user images identified above, a three-dimensional virtual space can be created. FIG. 4A shows a first view 400 of the three-dimensional space from a first perspective. Note that the first view shows various objects retained from the input images, such as the bookshelf 304, couch 312, curtains 314, chair 322, and chair 324. In addition, the first view shows some newly-generated objects that were generated by a generative image model, such as lamp 402 and plant 404.

FIG. 4B shows a second view 410 of the three-dimensional virtual space from a second perspective. The second view also shows objects retained from the input images, such as the couch 312, curtains 314, chair 322, chair 324, and sofa 332. In addition, the second view shows the lamp 402 and plant 404 that were generated by the generative image model, as well as an end table 412 also generated by the generative image model. FIG. 4C shows an edited second view 420 where a user has added a lamp 422 to the end table 412.

### Specific Algorithm

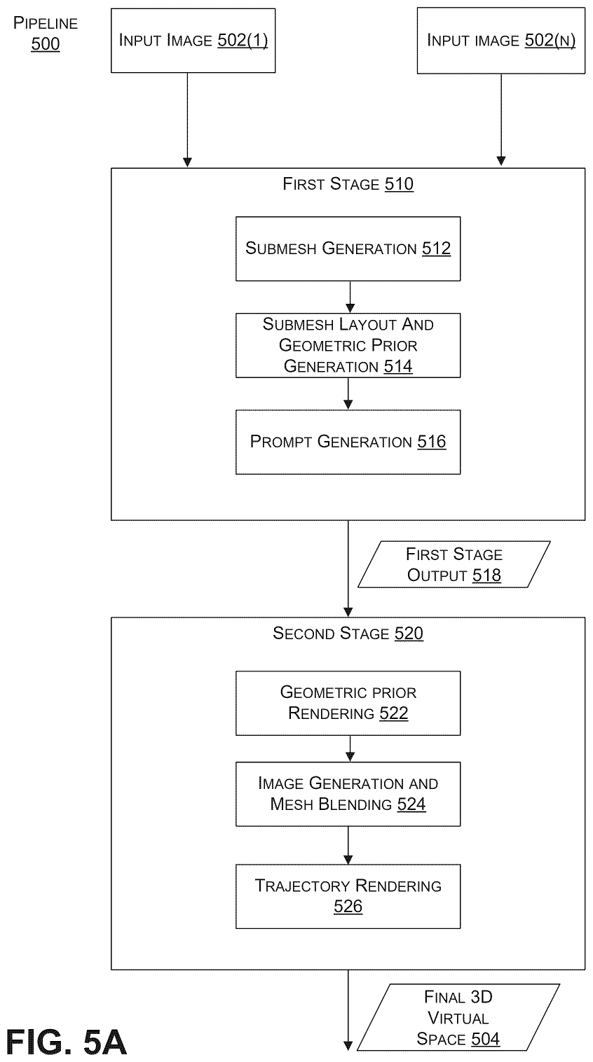

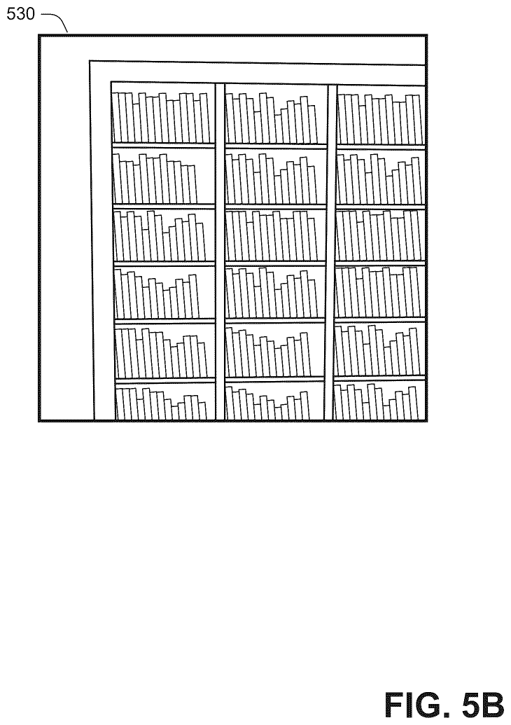

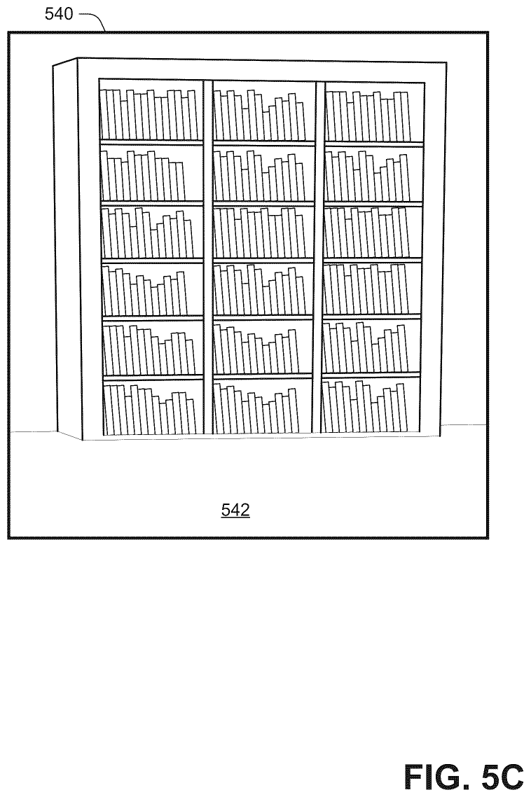

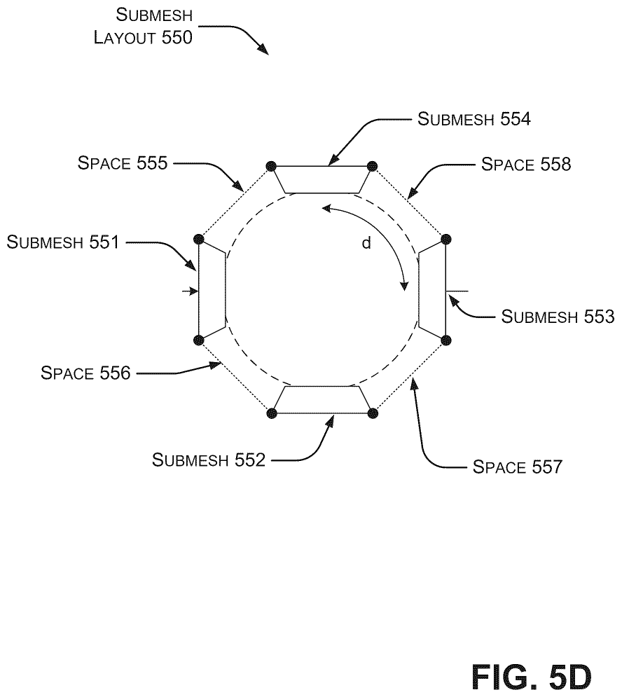

The following describes a specific algorithm that can be employed to create unified three-dimensional virtual spaces by blending input images that depict multiple physical spaces. As shown in FIG. 5A, the algorithm is structured as a pipeline 500 that takes input images 502(1) through 502(n) as its input, and outputs a 3D mesh incorporating the context of each input image into a final three-dimensional virtual space 504. The pipeline is structured into two main stages. The first stage 510 runs once per generation, whereas the second stage 520 involves an iterative process.

The first stage 510 of the pipeline 500 begins with submesh generation 512, which transforms the two-dimensional input images 502(1) through 502(n) into three-dimensional submeshes. This process starts with an image preprocessing step, after which depth estimation and world projection are used to create the three-dimensional submeshes from the processed images. Following this, submesh layout and geometric prior layout generation 514 is performed. First, the submeshes are aligned to a common floor plane (e.g., through a random sample consensus-based method or “RANSAC”), combined with a semantic segmentation model. The aligned submeshes are then arranged based on a parametric layout technique to obtain a submesh layout, which is used to generate one or more geometric priors. To conclude the first stage, prompt generation 516 can generate textual image generation prompts using generative language model 100 or another model, such as GPT-4 (Achiam, et al., “Gpt-4 technical report,” arXiv preprint arXiv: 2303.08774). The image generation prompts can be based on one or more descriptions of the input images, such as captions inferred by BLIP-2 (Li, et al., “Blip-2: Bootstrapping language-image pre-training with frozen image encoders and large language models,” International conference on machine learning, July 2023, pp. 19730-19742, PMLR).

The second stage 520 of the pipeline 500 involves iterative blending and completion of the three-dimensional virtual space based on first stage output 518, which can include the geometric priors and the image generation prompts. For each iteration of the second stage, geometric prior rendering 522 can render the geometric priors from the first stage 510 based on the submesh layout. The geometric priors can function as a guide for the shape of the three-dimensional virtual space. The geometric priors are combined with the image generation prompts from the first stage 510 for image generation and mesh blending 524, which iteratively blends the disparate submeshes into a unified environment. Once the blending process completes, the mesh is completed by trajectory rendering 526, which follows a customized mesh completion trajectory that fills the gaps in the current three-dimensional virtual space, resulting in final three-dimensional virtual space 504.

### Details of Pipeline First Stage

The first stage 510 of the pipeline 500 sets the foundation for the spatial structure of the resulting three-dimensional virtual space. Through image preprocessing and depth estimation techniques, two-dimensional input images 502(1) through 502(n) are extrapolated into three-dimensional submeshes at submesh generation 512. A three-dimensional submesh can be created from each two-dimensional input image. The set of input images can first be preprocessed before being projected into 3D world space. For instance, the presence of people in each input image can be detected using a semantic segmentation model, such as Oneformer (Jain, et al., “Oneformer: One transformer to rule universal image segmentation,” In Proceedings of the IEEE/CVF Conference on Computer Vision and Pattern Recognition, 2023, pp. 2989-2998). If a person is a detected in a given input image, the relevant area is removed and inpainted with generative image model 200. For instance, input image 300 (FIG. 3A) can be processed by removing the user 302 shown in the image and inpainting the area where the user has been removed, resulting in preprocessed image 530 shown in FIG. 5B.

Following this, the resulting image can be cropped to a dimension of 512×512 pixels, ensuring compatibility with the models used in subsequent stages of the pipeline. For instance, some implementations can employ components from Text2room (Höllein, et al., “Text2room: Extracting textured 3d meshes from 2d text-to-image models,” In Proceedings of the IEEE/CVF International Conference on Computer Vision, 2023, pp. 7909-7920). After person removal and image cropping, the submeshes for each image can be generated using a depth estimation model to calculate the absolute depth from each of the processed input images, and then projecting that image into three-dimensional world coordinates based on this depth and its color data.

Next, the respective submeshes are aligned to a common floor plane. To address the challenge of integrating multiple input images with varying viewpoints and angles into a coherent 3D space, the disclosed techniques provide a floor plane alignment technique to address differences in perspectives of the input images. This process reconciles differences in projection and provides the spatial consistency for subsequent processing.

Submesh layout and geometric prior layout generation 514 can start by applying an algorithm such as RANSAC to a plane corresponding to the submesh's floor in world space. The floor in each of the submeshes can be detected by taking the labels of a semantic segmentation map output by a semantic segmentation model such as OneFormer after processing the input images. This resulting semantic map is then projected into world space, replacing the RGB colors of the submesh with colors representing semantic labels. RANSAC is then utilized to identify a plane predicted to correspond to the points that are assigned a label floor-like object labels (e.g., floor, carpet) in the semantically labeled submesh. On occasion, the depth estimation model might position a pixel at the edge of a table, implying it is part of the table structure. However, the semantic segmentation model might still identify that same pixel as being on the edge of the floor area. Due to such discrepancies, in some implementations, vertices that are more than 0.3 meters above or below the median Y-coordinate are excluded to prevent the inclusion of ambiguous points.

If a floor is identified in a given input image, a RANSAC-based algorithm is subsequently used to fit a plane to the submesh floor. During this iterative procedure, three random points are sampled to define a candidate plane. Distances from all points to this candidate plane are computed, with those within a set threshold deemed as inliers. To ensure that the hypothetical plane is the floor, two additional heuristics are used: whether the plane's orientation is closest to the target reference plane normal and its size in the X and Z axes. Specifically, the orientation of the plane must be within 45 degrees of the target plane normal, effectively ensuring the plane is not excessively tilted. Furthermore, the orientation of each of the hypothetical planes' normal vector is required to have a positive Y-component to guarantee the mesh is not inverted. At the same time, the extent of the inlier points in the X and Z axes is checked against a threshold of 0.5 meters to confirm the plane is of sufficient size. After selecting the best floor plane candidate, a rotation matrix is formulated to align the plane's normal with the upward Y-axis. This rotation is applied after which the floor is translated to Y=0 and set the minimum Z-coordinate to 0.

In some cases, input images may not contain a floor, which can prevent a valid plane from being fitted. For example, input image 300 (FIG. 3A) and preprocessed image 530 (FIG. 5B) do not show a floor. In such situations, a generative technique can be used to generate a floor suitable for alignment. For instance, FIG. 5C shows a processed image 540, obtained by adding a floor 542 to preprocessed image 530 using generative image model 200. One way to add the floor involves a five-step trajectory, looking downward (from −5 to −30 degrees), while moving backward (from 1 to 1.5 meters) and upwards (from 0.3 to 1 meter), relative to the initial view of the submesh. For each generative step of the trajectory, a prompt containing a custom floor description can be input to the generative image model 200. This floor description can be generated by generative language model 100. The generative image model can be prompted to describe the floor based on an image description of the submesh, such as a description produced by BLIP-2.

Given a set of submeshes, each aligned to a universal floor plane, a submesh layout that resembles an open space can be created. This approach enables virtual reality telepresence scenarios, enabling users to position themselves in distinct segments while maintaining an unobstructed line of sight. Each submesh is oriented towards the center of this unified space, ensuring clear visibility between all submeshes. The submeshes are positioned on a circle facing inward, and the diameter of the circle is determined by a configurable interspatial distance parameter, d, which controls the desired size of the blended space between the submeshes. FIG. 5D shows an example submesh layout 550, with submesh 551, submesh 552, submesh 553, and submesh 554 arranged facing inward. Submesh 551 can correspond to input image 300, submesh 552 can correspond to input image 310, submesh 553 can correspond to input image 320, and submesh 554 can correspond to input image 330. The submeshes are separated by space 555, space 556, space 557, and space 558. As described more below, generative image models can populate the spaces with objects according to the image generation prompts output by first stage 510.

Given the aligned set of submeshes, a geometric prior mesh is generated to serve as guidelines for shaping the unified space. To define this mesh, a convex hull is generated from a top-down view of the submesh layout. Based on this convex hull, a three-dimensional mesh is constructed with faces representing the floor, walls, and ceiling. The height of this mesh can be set to the height of the tallest submesh, or to two meters, if none is taller, which may occur if none of the input images includes a ceiling. The floor, ceiling, and walls are assigned colors based on the semantic label colors of each respective object, e.g., from the ADE20K dataset (Zhou, et al., “Scene parsing through ade20k dataset,” In Proceedings of the IEEE conference on computer vision and pattern recognition, 2017, pp. 633-641). This geometric prior mesh is utilized in second stage 520 for rendering geometric priors for iterative submesh blending and completion.

Prompt generation 516 can employ generative language model 100 to generate textual prompts that infer contextually relevant contents of the blended regions of the unified space. These textual image generation prompts are used in the iterative blending process of second stage 520. For instance, the prompt generation can involve obtaining an image description for each submesh using BLIP-2, along with a rotation value that indicates its direction as viewed from the center of the submesh layout. Then, the generative language model 100 is instructed to act as a creative interior architect and photographer, who is well-skilled at interpreting descriptions of images taken from a fixed position in the center of a complex space. After initialization of the generative language model, each pair of rotation values and submesh descriptions is passed to the generative language model, which is tasked to creatively infer descriptions of the unseen (to be blended) areas within the mesh (e.g., space 555, space 556, space 557, and space 558). These image generation prompts not only encourage the generation of contextually relevant and spatially coherent content but can also avoid repetitive object placements throughout the mesh.

### Second Pipeline Stage

Building upon the established submesh layout, the second stage 520 integrates the submeshes to obtain the final three-dimensional virtual space 504. Utilizing the geometric priors generated in the previous stage as a guide for the shape of the unified space and contextually adaptive textual prompts to direct the image generation process, the second stage iteratively blends the disparate submeshes into a unified environment.

To address the objective of generating spaces with specific shapes, the second stage 520 utilizes a collection of prior images to guide the iterative, text-conditioned image completion component of the mesh blending and completion process. For instance, the image completion can be guided using ControlNet (Zhang, et al., “Adding conditional control to text-to-image diffusion models,” In Proceedings of the IEEE/CVF International Conference on Computer Vision, 2023, pp. 3836-3847). Each time a view of the submeshes is rendered, a set of prior images are rendered from the same camera viewpoint based on the geometric mesh prior output by first stage 510, which is spatially aligned with the submesh layout 550. There are several different types of priors that can be employed including a depth prior, a layout prior, and a semantic prior. A depth prior can be used as a hard room layout constraint for generating spaces similar to predefined geometry (e.g., the geometric prior output by first stage 510). The depth prior can be defined by rendering depth values in grayscale within the range of 0-255, where 255 represents the closest point and 0 the farthest point. A layout prior guides the spatial layout of the environment without limiting the space's content and can be generated by calculating depth gradients using the Sobel operator to form surface normals. Subsequently, the magnitude of these surface normals is calculated to assess surface variations. This magnitude is then processed with Canny edge detection to produce an image that effectively outlines the space's layout with white lines outlining the wall, floor, and ceiling on a black background. A semantic prior represents a semantic map of the layout elements within the environment, which can serve as a hard room layout constraint for generating empty open spaces, with direct definition of the floor, walls, and ceiling.

These priors can be stacked and composed together using multiple ControlNet instances, thus allowing for the adjustment of each prior's influence on the image output. This approach enables control over not only the space's layout but also the volume of content generated. For instance, employing only the layout prior can guide the generative image model 200 to generate a space with a specific room structure while permitting the room content (e.g., furniture) to be generated without restrictions. An additional depth prior can be added with the aim to guide the image completion model to position furniture closer to the depth values specified by the depth prior, resulting in the generation of furniture that is more likely close to the wall (e.g., sofas, bookshelves). Finally, the semantic prior can provide additional guidance on the types of structural elements that should be included in the generated images as part of the iterative mesh blending and completion process.

The depth prior image and semantic prior image can be used with pretrained ControlNet models. The layout prior can used with a custom ControlNet model, referred to below as ControlNet-Layout, which can be trained as follows. ControlNet-Layout can be trained on a dataset containing 13,182 images. Rather than utilizing the images from the existing dataset for generation, images can be generated using the semantic segmentation maps from SUN-RGBD (Song, et al., “Sun rgb-d: A rgb-d scene understanding benchmark suite,” In Proceedings of the IEEE conference on computer vision and pattern recognition, 2015, pp. 567-576) and LSUN (Yu, et al., “LSUN: Construction of a large-scale image dataset using deep learning with humans in the loop,” 2015, arXiv preprint arXiv: 1506.03365 and Zhang, et al., “Large-scale scene understanding challenge: Room layout estimation,” September 2015, In CVPR Workshop) resized to a resolution of 512×512 pixels. This can be accomplished by employing a set of fixed seeds. This strategy enhances the quality of the generated images and to increase the diversity of the dataset, enabled by the generation of multiple images per extracted segmentation map. The training process can be initialized with the weights of the ControlNet MLSD model and tuned using a learning rate of 1×10-5 and a batch size of 4.

The iterative process of second stage 520 involves image generation and mesh blending 524, which can blend the submeshes with generated image content according to the predefined submesh layout. To enable the blending capabilities of the second stage, the context window of the generative image model 200 can be broadened by increasing the resolution from 512×512 (the resolution used by text2room) to 512×1280 while maintaining the original field-of-view of 55 degrees. This can be implemented by incorporating a A1111 WebUI plugin implementation4 of MultiDiffusion (Bar-Tal, et al., “Multidiffusion: Fusing diffusion paths for controlled image generation,” 2023, In Proceedings of the 40th International Conference on Machine Learning, ICML'23, Vol. 202, JMLR.org, Honolulu, Hawaii, USA, pp. 1737-1752). By increasing the width of the images generated throughout the blending process, the capacity of the generative image model to account for these neighboring spaces in a single step is enhanced.

This process results in a mesh that horizontally integrates disparate spaces, thereby determining the geometry and contents of the unified space from a central perspective. However, at this point in the process, the majority of the floor and ceiling are absent, and the mesh will contain a significant number of gaps and missing areas to be filled. To address the completion of the remaining space, an additional set of trajectories is used. First, trajectories directed upwards and downwards are generated to complete the majority of the missing sections of the floor and ceiling.

Next, trajectory rendering 526 defines a set of trajectories for each submesh. These trajectories interpolate both the position and rotation of a camera viewpoint, starting from a central position within the unified space and initially directed towards a specific submesh. The trajectory interpolates the camera viewpoint across completion steps, adjusting the position to conclude at the center of the submesh and to be facing towards either the left or right neighboring submesh. Throughout this process, the textual prompt passed to the image completion model is selected based on the cameras viewpoint with respect to the blended areas of the environment from the set of previously LLM-generated descriptions.

An additional trajectory is added to simulate a user looking around the unified space from the centerpoint of their submesh to ensure that the mesh generation process accounts for and fills in gaps that would be noticeable from typical user vantage points within the virtual environment. To represent the natural variation in a user's gaze, a degree of randomness is introduced into this set of trajectories. Once these final completion trajectories finish rendering, the unified space is complete and ready for usage, e.g., in a virtual reality telepresence system.

### Example System

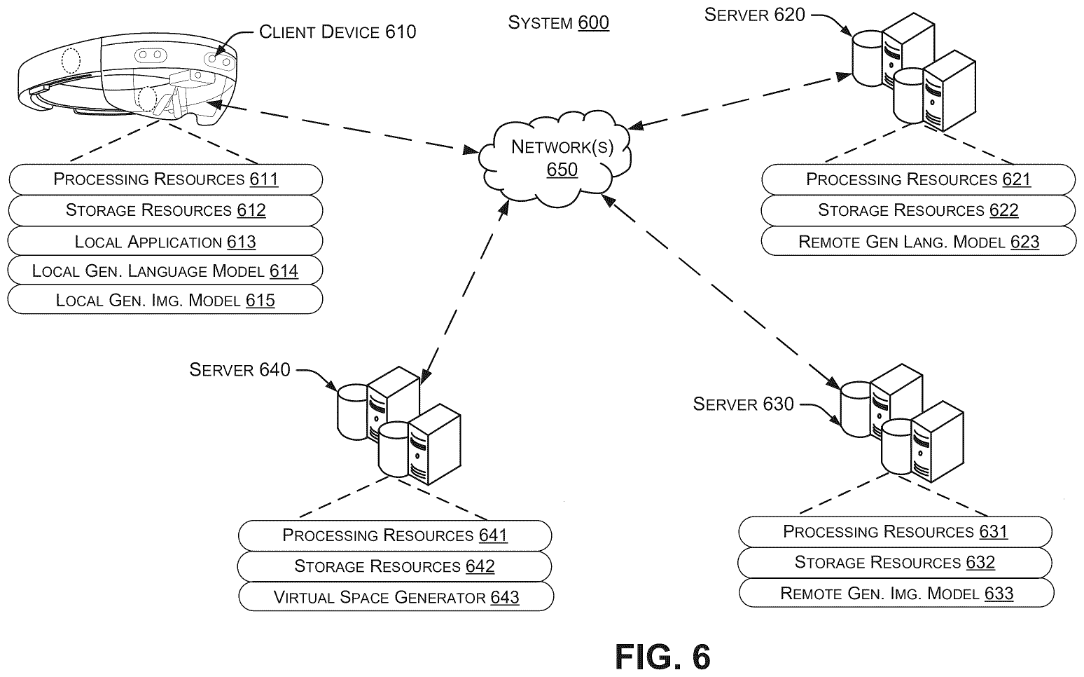

The present implementations can be performed in various scenarios on various devices. FIG. 6 shows an example system 600 in which the present implementations can be employed, as discussed more below.

As shown in FIG. 6, system 600 includes a client device 610, a server 620, a server 630, and a server 640, connected by one or more network(s) 650. Note that the client device can be embodied both as a mobile device such as smart phones or tablets, as well as stationary devices such as desktops, server devices, etc. Likewise, the servers can be implemented using various types of computing devices. In some cases, any of the devices shown in FIG. 6, but particularly the servers, can be implemented in data centers, server farms, etc.

Client device 610 can have processing resources 611 and storage resources 612, server 620 can have processing resources 621 and storage resources 622, server 630 can have processing resources 631 and storage resources 632, and server 640 can have processing resources 641 and storage resources 642. Each of these devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 610 can include one or more local application(s) 613, such as a virtual reality application or video game. The client device can also include a local generative language model 614, e.g., a local instance of generative language model 100 as shown in FIG. 1. The client device can also include a local generative image model 615, e.g., a local instance of generative image model 200 as shown in FIG. 2.

Server 620 can host remote generative language model 623, e.g., a remote instance of generative language model 100 as shown in FIG. 1. Server 630 can host a remote generative language model 633, e.g., a remote instance of generative image model 200 as shown in FIG. 2. Server 640 can host virtual space generator 643, which can generate virtual spaces as described above.

For instance, client device 610 can upload one or more input images to the virtual space generator, which can then implement pipeline 500 to generate a three-dimensional virtual space as described above. Then, a user of the client device can interact with the three-dimensional virtual space. For instance, in some cases, the client device is implemented as a virtual reality headset having a display, where movement of the user's head when wearing the headset results in changing viewpoints and different portions of the three-dimensional space corresponding to the current viewpoint are rendered by the virtual reality headset. In other cases, the client device could be a mobile phone, where movement of the mobile phone and/or touchpad inputs could be used to change the viewpoint. In other cases, the client device is a laptop, where a trackpad and/or directional arrows on a keyboard are used to change the viewpoint.

Further, note that system 600 can include multiple client devices that each provide different images to the virtual space generator 643 on server 640. Then, the virtual space generator can distribute the three-dimensional virtual space to each of the client devices, which can then participate in a shared experience. For instance, users could conduct a teleconference in a shared three-dimensional virtual space that is based on their actual respective spaces as captured by a webcam during the teleconference.

### Example Method

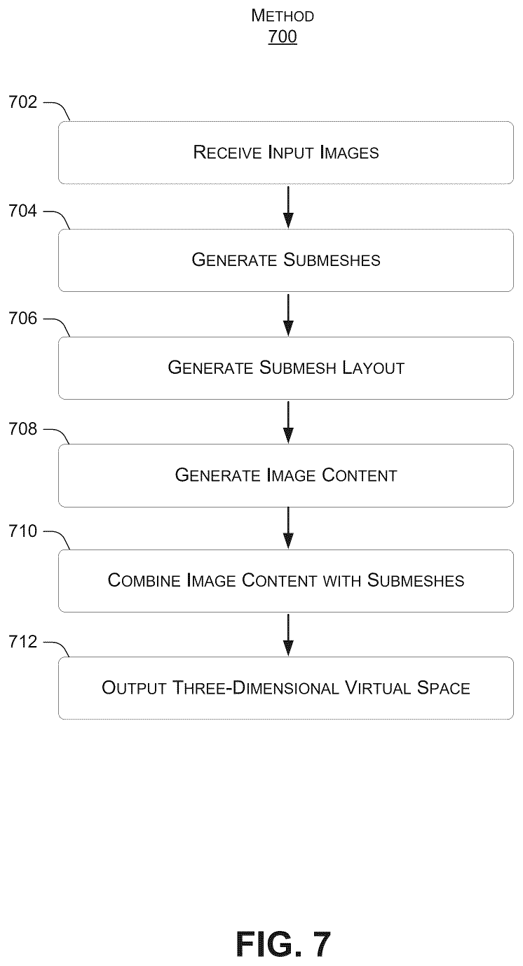

FIG. 7 illustrates an example computer-implemented method 700, consistent with some implementations of the present concepts. Method 700 can be implemented on many different types of devices, e.g., by one or more cloud servers, by a client device such as a laptop, tablet, or smartphone, or by combinations of one or more servers, client devices, etc.

Method 700 begins at block 702, where multiple two-dimensional input images are received. For instance, in some cases, the input images are received from different client devices during a teleconference involving distributed users. In other cases, the input images can be received from a single device or retrieved from local storage.

Method 700 continues at block 704, where three-dimensional submeshes are generated for each of the input images. For instance, a depth estimation model can be applied to the input images to obtain depth data. The input images can be projected into three-dimensional world coordinates based on the depth data and color data from the input images to obtain the three-dimensional submeshes.

Method 700 continues at block 706, where a submesh layout is generated from the three-dimensional submeshes. For instance, the submeshes can be aligned to a common floor plane, and then arranged on a circle facing inward. Spaces can be provided between each three-dimensional submesh.

Method 700 continues at block 708, where image content is generated with a generative image model. For instance, a generative language model can be employed to generate image generation prompts from descriptions of the input images. Then, the image generation prompts can be input to the generative image model.

Method 700 continues at block 710, where the image content is combined with the submeshes. For instance, the image content generated by the generative image model can be blended with the submeshes to create the final three-dimensional virtual space.

Method 700 continues at block 712, where the final three-dimensional virtual space is output. For instance, the final three-dimensional virtual space can be sent to one or more client computing devices for rendering, rendered locally, stored in persistent storage, etc.

In some cases, some or all of method 700 is performed by a server. In other cases, some or all of method 700 is performed on another device, e.g., a client device, or distributed across multiple devices.

### ADDITIONAL IMPLEMENTATIONS

The techniques described above can be employed for a wide range of applications. For instance, consider the teleconferencing scenarios described above. Users located in different places can conduct a virtual, three-dimensional teleconference in a virtual space that incorporates objects and geometric characteristics from their own real, physical spaces captured by a webcam. Users can also add objects to the space or remove objects from the space, modify individual portions of the space, etc.

For instance, referring back to FIG. 4C., there are several ways that a user could add lamp 422 on top of end table 412. In one implementation, the user could say the words “Please put a lamp on the end table.” A new image generation prompt could be generated and then the generative image model could generate one or more images showing the lamp on the end table, as requested. As another example, a raycasting technique could be used to designate an area where a new object should be generated, e.g., the user could point to a location on the floor where they would like to place a plant or item of furniture.

In some implementations, users can also remove and/or modify existing content from the three-dimensional virtual space. For instance, a user might point at plant 404 and say “make the plant shorter,” and a new prompt can be provided to the generative image model to generate a shorter plant. As another example, a user could say “make the environment less bright,” and the overall brightness of the three-dimensional virtual space could be dimmed. As another example, the user could request a change to the overall layout, e.g., so that chair 322 and chair 324 are next to the bookshelf 304. This could result in regenerating the entire three-dimensional virtual space with a modified layout, e.g., where the submesh for input image 300 is immediately adjacent to the submesh for input image 320.

In addition, note that some implementations may provide three-dimensional video animations in a three-dimensional virtual space. For instance, a three-dimensional virtual space could be provided with a background visible through a window, where the background includes animated rain or snow. As another example, a user could request placement of a three-dimensional globe within a three-dimensional virtual space, and then users could rotate the globe to view different parts of the globe. In other cases, the animated rain or snow and/or the globe could be suggested by a generative language model to be included in the three-dimensional virtual space.

In still further implementations, directional audio can be implemented as part of a three-dimensional virtual space. For instance, a generative language model could suggest placement of a door in a three-dimensional virtual space, and users could knock on the door. Directional audio could be rendered to each user in the three-dimensional space so that the sound appears to be traveling from the door to the user. As another example, a user could request placement of a virtual musical instrument (e.g., a drum), and the user could then play the virtual musical instrument while directional audio is rendered from the location of the virtual musical instrument to users in the virtual three-dimensional space.

Also, note that some implementations may involve using machine learning for additional aspects of the disclosed concepts. For instance, a machine learning model could receive user input images and determine a submesh layout from the user input images. For instance, the model could be trained or tuned using examples of input images and corresponding submesh layouts, and generate the submesh layouts directly from input images. As another example, a generative model could receive prior examples of one or more submesh layouts and corresponding input images via a prompt, and then generate a new submesh layout from one or more other input images using prior examples for in-context learning.

### Technical Effect

The disclosed techniques provide for improved human-computer interaction by allowing users to provide input images that are employed for generating three-dimensional virtual spaces. Consider an alternative where users attempt to describe the three-dimensional virtual space that they wish to create. Users could attempt to verbally describe their own environments, e.g., a first user could state that their room includes a bookshelf as shown in FIG. 3A, a second user could describe a couch and curtains as shown in FIG. 3B, etc. However, it would be very difficult for a user to precisely describe the shape, color, and geometry of every object as well as their background in a manner that could realistically be employed by a generative image model to create three-dimensional virtual space that accurately incorporates each user's environment.

Using the disclosed techniques, users can provide input images of their own environments. This allows for generation of three-dimensional virtual spaces that retain objects and geometry from the users' own environments, without the user necessarily attempting to describe the environments themselves. As a consequence, user input can be greatly reduced while providing far more fidelity to the actual environments.

### Device Implementations

As noted above with respect to FIG. 6, system 600 includes several devices, including a client device 610, a server 620, a server 630, and a server 640. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state storage devices (e.g., flash, nonvolatile memory express, and/or serial advanced technology attachment devices), optical storage devices (e.g., CDs, DVDs, etc.), among others. As used herein, the terms “computer-readable media” and “computer-readable medium” can include signals. In contrast, the terms “computer-readable storage media” and “computer-readable storage medium” excludes signal. Computer-readable storage media includes “computer-readable storage devices.” Examples of computer-readable storage devices include volatile storage media, such as RAM, and non-volatile storage media, such as hard drives, optical discs, and flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 650. Without limitation, network(s) 650 can include one or more local area networks (LANs), wide area networks (WANs), the Internet, and the like.

### ADDITIONAL EXAMPLES

Various examples are described above. Additional examples are described below. One example includes a computer-implemented method comprising receiving input images, generating three-dimensional submeshes from the input images, generating a submesh layout from the three-dimensional submeshes, the submesh layout having spaces between the three-dimensional submeshes, using a generative image model, generating image content for the spaces in the submesh layout, combining the generated image content with the three-dimensional submeshes into a three-dimensional virtual space, and outputting the three-dimensional virtual space.

Another example can include any of the above and/or below examples where the method further comprises detecting a person in a particular input image using a semantic segmentation model and removing the person and inpainting a background behind the person in the particular image with the generative image model prior to generating a particular three-dimensional submesh for the particular input image.

Another example can include any of the above and/or below examples s where generating the three-dimensional submeshes comprises employing a depth estimation model to estimate depth data from the input images.

Another example can include any of the above and/or below examples where generating the three-dimensional submeshes comprises projecting the input images into three-dimensional world coordinates based on the depth data and color data from the input images.

Another example can include any of the above and/or below examples where generating the submesh layout comprises aligning the three-dimensional submeshes to a common floor plane.

Another example can include any of the above and/or below examples where the method further comprises using the generative image model, adding a floor to a particular input image that does not show a floor.

Another example can include any of the above and/or below examples where generating the submesh layout comprises positioning the three-dimensional submeshes on a circle facing inward.

Another example can include any of the above and/or below examples where the method further comprises obtaining input image descriptions from the input images using a computer vision model and prompting the generative image model to generate the image content based on the input image descriptions obtained from the computer vision model.

Another example can include any of the above and/or below examples where the prompting the generative image model comprises providing the input image descriptions to a generative language model, receiving image generation prompts from the generative language model, and inputting the image generation prompts to the generative image model, the generative image model generating the image content in response to the image generation prompts.

Another example can include any of the above and/or below examples where the image generation prompts describe objects to be placed in the spaces in the submesh layout.

Another example can include any of the above and/or below examples where the method further comprises blending the three-dimensional submeshes together with the image content generated by the generative language model.

Another example can include any of the above and/or below examples where the method further comprises obtaining one or more prior images from rendered views of the three-dimensional submeshes and guiding the blending using the one or more prior images.

Another example can include any of the above and/or below examples where the prior images comprise one or more of a depth prior image, a layout prior image, or a semantic prior image.

Another example can include any of the above and/or below examples where the method further comprises completing missing floor and ceiling sections using the generative image model.

Another example can include any of the above and/or below examples where the generating the image content comprises generating trajectories for the three-dimensional submeshes and selecting image generation prompts for generating the image content based on camera viewpoints corresponding to trajectories.

Another example can include any of the above and/or below examples where the method further comprises generating one or more animated objects or one or more directional sounds within the three-dimensional virtual space.

Another example can include a system comprising a processor and a storage medium storing instructions which, when executed by the processor, cause the system to receive a three-dimensional virtual space, the three-dimensional virtual space having been generated from multiple input images according to a submesh layout and having image content generated by a generative image model for spaces in the submesh layout and render portions of the three-dimensional virtual space in response to received user input.

Another example can include any of the above and/or below examples where the instructions, when executed by the processor, cause the system to receive a particular user input requesting to add an object at a designated location in the three-dimensional virtual space, prompt the generative image model to generate an image of the object at the designated location, and add the generated image of the object to the three-dimensional virtual space.

Another example can include any of the above and/or below examples, provided in a virtual reality headset having a display, the received user input corresponding to changing viewpoints of a user wearing the virtual reality headset.

Another example can include a computer-readable storage medium storing instructions which, when executed by a processing device, cause the processing device to perform acts comprising receiving input images, generating three-dimensional submeshes from the input images, generating a submesh layout from the three-dimensional submeshes, the submesh layout having spaces between the three-dimensional submeshes, using a generative image model, generating image content for the spaces in the submesh layout, and combining the generated image content with the three-dimensional submeshes into a three-dimensional virtual space.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
receiving input images;
generating three-dimensional submeshes from the input images;
generating a submesh layout from the three-dimensional submeshes, the submesh layout having spaces between the three-dimensional submeshes;
using a generative image model, generating image content for the spaces in the submesh layout;
combining the generated image content with the three-dimensional submeshes into a three-dimensional virtual space; and
outputting the three-dimensional virtual space.

2. The computer-implemented method of claim 1, further comprising:
detecting a person in a particular input image using a semantic segmentation model; and
removing the person and inpainting a background behind the person in the particular image with the generative image model prior to generating a particular three-dimensional submesh for the particular input image.

3. The computer-implemented method of claim 1, wherein generating the three-dimensional submeshes comprises:
employing a depth estimation model to estimate depth data from the input images.

4. The computer-implemented method of claim 3, wherein generating the three-dimensional submeshes comprises:
projecting the input images into three-dimensional world coordinates based on the depth data and color data from the input images.

5. The computer-implemented method of claim 4, wherein generating the submesh layout comprises aligning the three-dimensional submeshes to a common floor plane.

6. The computer-implemented method of claim 5, further comprising:
using the generative image model, adding a floor to a particular input image that does not show a floor.

7. The computer-implemented method of claim 1, wherein generating the submesh layout comprises positioning the three-dimensional submeshes on a circle facing inward.

8. The computer-implemented method of claim 7, further comprising:
obtaining input image descriptions from the input images using a computer vision model; and
prompting the generative image model to generate the image content based on the input image descriptions obtained from the computer vision model.

9. The computer-implemented method of claim 8, wherein the prompting the generative image model comprises:
providing the input image descriptions to a generative language model;
receiving image generation prompts from the generative language model; and
inputting the image generation prompts to the generative image model, the generative image model generating the image content in response to the image generation prompts.

10. The computer-implemented method of claim 9, wherein the image generation prompts describe objects to be placed in the spaces in the submesh layout.

11. The computer-implemented method of claim 10, further comprising:
blending the three-dimensional submeshes together with the image content generated by the generative language model.

12. The computer-implemented method of claim 11, further comprising:
obtaining one or more prior images from rendered views of the three-dimensional submeshes; and
guiding the blending using the one or more prior images.

13. The computer-implemented method of claim 12, the prior images comprising one or more of a depth prior image, a layout prior image, or a semantic prior image.

14. The computer-implemented method of claim 11, further comprising completing missing floor and ceiling sections using the generative image model.

15. The computer-implemented method of claim 11, wherein the generating the image content comprises:
generating trajectories for the three-dimensional submeshes; and
selecting image generation prompts for generating the image content based on camera viewpoints corresponding to trajectories.

16. The computer-implemented method of claim 1, further comprising generating one or more animated objects or one or more directional sounds within the three-dimensional virtual space.

17. A system comprising:
a processor; and
a storage medium storing instructions which, when executed by the processor, cause the system to:
receive a three-dimensional virtual space, the three-dimensional virtual space having been generated from multiple input images according to a submesh layout and having image content generated by a generative image model for spaces in the submesh layout; and
render portions of the three-dimensional virtual space in response to received user input.

18. The system of claim 17, wherein the instructions, when executed by the processor, cause the system to:
receive a particular user input requesting to add an object at a designated location in the three-dimensional virtual space;
prompt the generative image model to generate an image of the object at the designated location; and
add the generated image of the object to the three-dimensional virtual space.

19. The system of claim 18, provided in a virtual reality headset having a display, the received user input corresponding to changing viewpoints of a user wearing the virtual reality headset.

20. A computer-readable storage medium storing instructions which, when executed by a processing device, cause the processing device to perform acts comprising:
receiving input images;
generating three-dimensional submeshes from the input images;
generating a submesh layout from the three-dimensional submeshes, the submesh layout having spaces between the three-dimensional submeshes;
using a generative image model, generating image content for the spaces in the submesh layout; and
combining the generated image content with the three-dimensional submeshes into a three-dimensional virtual space.
